(19) United States
(12) Patent Application Publication
(10) Pub. No.: US 2004/0023837 A1
(43) Pub. Date: Feb. 5, 2004

(54) Stabilised liquid compositions containing active chlorine

(76) Inventors: Andrea Zanardi, Bergamo (IT); Italo Accardi, Bergamo (IT)

Correspondence Address: Walter H. Schneider, 21530 BEECHWOOD RD., CIRCLEVILLE, OH, 43113, US

(21) Appl. No.: 10/616,775

(22) Filed: Jul. 10, 2003

(30) Foreign Application Priority Data
Jul. 30, 2002 (IT) MI2002A0016943

(51) Int. Cl. C01B 11/00; A62D 9/00; C01B 7/00; C09K 3/00; A62D 3/00; C11D 1/00

(52) U.S. Cl. 510/499; 252/186.36; 252/186.37

(57) ABSTRACT

Liquid compositions containing alkali or alkaline-earth hypochlorites, and possibly other active chlorine releasers such as trichlorocyanuric acid, dichlorocyanuric acid and its alkali salts, with special reference to those used for bleaching and sanitising fabrics and surfaces.

### TECHNICAL FIELD OF REFERENCE

The present invention relates to liquid compositions containing alkali or alkaline-earth hypochlorites, and possibly other active chlorine releasers such as trichlorocyanuric acid, dichlorocyanuric acid and its alkali salts, with special reference to those used for bleaching and sanitising fabrics and surfaces.

### BACKGROUND OF THE INVENTION

Liquid compositions containing chemical bleaching and disinfecting agents are widely used in domestic and industrial cleaning, personal hygiene and the pharmaceutical industry.

As active agents they can contain salts of hypochlorous acid, active chlorine releasers such as trichlorocyanuric acid, dichlorocyanuric acid and its alkali salts, hydrogen peroxide or its precursor peroxides.

Compositions based on sodium hypochlorite are the most widely used because of their cost-effectiveness.

Numerous patents such as U.S. Pat. No. 5,549,842, US 5,279,755, US 5,529,711 and EP 0649898 claim detergent compositions based on hypochlorite.

However, hypochlorite-based compositions tend to lose their initial viscosity with time, their active chlorine content declines, and other characteristics, such as cleansing activity and colour, are modified.

Among the systems designed to prevent this deterioration, U.S. Pat. No. 6,083,422 discloses stabilisers constituted by a series of benzenes variously substituted with functional groups.

Various systems which stabilise the active chlorine content are also known; the best-known include the use of sodium periodate, phosphonic acid, phosphates and phosphonates in general, phytic acid, silicates, amide, 2-oxazolidinones, arylsulphonamides and derivatives thereof, multidentate heteroaromatic systems, alkaline metal heptonate, alkaline metal boroheptonate, isocyanuric acid, ferrocyanide and imidodisulphate. These systems, and others which act by means of different mechanisms, are cited in patents U.S. Pat. No. 4,065,545, JP 1164701, DE 3308850, U.S. Pat. Nos. 3,452,137, 2,438,781, GB 1282906, U.S. Pat. Nos. 5,380,458, 4,898,681, GB 528125, U.S. Pat. No. 2,918,351, EP 267707, U.S. Pat. Nos. 2,170,108, 3,461,202 and FR 880965.

### SUMMARY OF THE INVENTION

This invention relates to a method of stabilising the viscosity and/or the active chlorine content of liquid compositions containing alkaline hypochlorites or other active chlorine releasers, with or without viscosity-regulating polymers, and optionally one or more additional ingredients such as surfactants, pH-regulating agents, optical brightening agents, dyes and perfumes.

In particular, the invention relates to the stabilisation of said compositions by adding stabilisers belonging to the class of hindered amines containing the group:

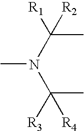

Preferred hindered amines have the following Formula I:

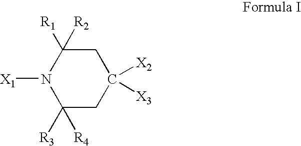

wherein R₁, R₂, R₃ and R₄, which may be the same or different, represent methyl or ethyl; X₁ represents H, methyl or ethyl groups or oxygen, the —OH group or the OR₅ group, wherein R₅ represents a linear or branched alkyl group C₁-C₄ or a cyclohexyl group; the symbol X₂ represents hydrogen, and the symbol X₃ represents the functional groups —OH or —NHR₅, wherein R₅ has the meaning described above; and the symbols X₂ and X₃, taken together, represent an oxygen atom=O.

The invention also relates to viscosified liquid compositions based on stabilised hypochlorites as described above as well as to mixtures of cross-linked or not cross-linked acrylic homo- or co-polymers comprising up to 50% by weight of hindered amines of formula I.

### DETAILED DESCRIPTION OF THE INVENTION

Liquid compositions containing hypochlorites, in particular sodium hypochlorite, or chlorocyanurates, in particular sodium dichlorocyanurate, for domestic or industrial use involving cleaning and sanitising fabrics or surfaces, are stabilised to maintain the general properties of the preparations, with special attention to their viscosity and rheological characteristics in general if said preparations contain polymeric viscosity regulators, and to the active chlorine content, by adding 0.001% to 5% of compounds of Formula I. The compounds of Formula I are readily soluble in water, and can be added unmodified to the preparations of the invention or pre-diluted in a suitable amount of water.

The active chlorine content of the compositions is between 0.5% and 10%, preferably between 1% and 5%. The preferred stabilisers according to the invention are compounds of Formula I, wherein R₁, R₂, R₃ and R₄ represent methyl and X₁ represents oxygen or the OH group; among them, those wherein X₁ represents oxygen, X₂ represents H and X₃ represents —OH are particularly preferred.

The pH is always alkaline, in particular between 10 and 14, and formulations with a pH of 12.5 are preferred in practice.

Other optional ingredients generally used are surfactants, viscosity regulators, builders, and minor components such as optical brightening agents, sequestering agents and stabilisers in general, abrasive substances, dyes and perfumes.

Anionic, non-ionic and amphoteric surfactants and mixtures thereof can be used as surfactants. The function of surfactants is to increase the wetting properties of the whitening preparations and increase their cleansing characteristics.

Anionic surfactants suitable for this purpose are alkyl ether sulphates, alkyl ether phosphates, alkyl aryl sulphonates, soaps of fatty acids, alkyl sulphates, paraffin sulphonates and decyl diphenyloxide sulphonate. Examples of non-ionic surfactants are ethoxylated alcohols, ethoxylated alkylphenols, ethoxylated fatty acids, sugar esters, alkanolamides and ethylene oxide/propylene oxide block copolymers.

Examples of amphoteric surfactants are ethoxylated amines, amine oxides and imidazoline. The specific nature of the surfactant is not critical for the purposes of the invention.

Rheology regulators are generally polymers, used in the proportion of 0.1% to 10% by weight of the bleaching composition. These polymers may be non-associative thickeners such as homopolymers or copolymers of carboxylic acids or olefinically unsaturated anhydrides such as acrylic and methacrylic acid, maleic anhydride or their esters, with free or salified carboxyl groups, in the form of powder or an emulsion or dispersion soluble in water, possibly after alkalinisation, or associative thickeners such as hydrophobically modified alkali-soluble acrylic emulsions, hydrophobically modified polymer polyols, modified urethane polyols or mixtures thereof. Homo- and co-polymers are generally cross-linked in such a way as to produce a given type of rheological behaviour. These polymers could also be applied in association with silicates modified with inorganic polyphosphates peptizers such as for Laponite®.

Polymers as described above are known on the market, for example, by the trademarks Carbopol, Ultrez, Acusol, Acrysol, Polygel, Synthalen and Stabylen.

Builders are materials which reduce the active concentration of calcium and magnesium ions. Any known builder can be used, such as trisodium phosphate, tetrasodium pyrophosphate, sodium tripolyphosphate, sodium silicates or the corresponding potassium salts.

Representative examples of chelating substances are alkali salts or nitrilotriacetic acid, ethylene diamine tetra-acetic acid, diethylene triamine penta-acetic acid and aminopolyphosphonates.

Stabilising agents act as follows: as chelating agents against metal impurities, as stabilisers in the presence of sunlight, and to reduce the breakdown of hypochlorite in formulations in general. The main stabilisers which have given excellent results in combination with the object of the invention include alkali metals periodate, iodated periodate-precursor compounds, potassium dichromate, calcium salts, phosphonic acid, phosphates and phosphonates in general, phytic acid, silicates, amides, 2-oxazolidinones, arylsulphonamides and derivatives, multidentate heteroaromatic systems, bromides, ferric chloride followed by filtration, alkali metals heptonate, alkali metals boroheptonate, pentaerythritol, inositol, sorbitol, mannitol, galactol, inositol, imidodisulphate, ferrocyanides, isocyanuric acid, sodium citrate, cerium ions and EDTA. The stabilisers may be present alone, in combination with one another, or wholly absent from the formulation containing hypochlorite and the object of the invention.

The required pH values can be obtained with carbonates, bicarbonates, pyrophosphates, hydroxides, phosphates, tetraborates or mixtures thereof.

Of the optical brightening agents, distyryl-diphenyl derivatives are preferred.

Experimental Part

In order to demonstrate the advantages of the invention, examples of detergent compositions stabilised according to the annexed claims are set out below.

All the percentages reported are expressed by weight; the viscosity values were determined with a Brookfield RVT viscosimeter at 20 rpm and 25° C., and expressed in centipoises.

The active chlorine content of the various preparations was measured with the well-known iodometric method.

### EXAMPLES 1 TO 7

In the examples described below, the compositions were prepared according to the following general procedure:

A thickening polymer was added to a suitable amount of water and then, after thorough dispersion, a stabiliser according to the invention. An alkaline substance was then added to adjust the pH to values greater than 10, and finally, the substance containing active chlorine, subsequently called AvCl₂ (Available Chlorine). Other substances characterising the composition, especially surfactants, were added subsequently.

Each composition was prepared with and without the stabilisers of the invention, in order to highlight any differences in behaviour.

Some examples include a comparison with compositions stabilised with p-methoxy-benzaldehyde, a type of stabiliser claimed in the most recent prior art, represented by patents U.S. Pat. No. 6,083,422 and WO 99/28427.

The compositions thus prepared were characterised in terms of viscosity and active available chlorine (AvCl₂) content, and then placed in an oven thermostated at 40° C., in closed glass containers, to simulate accelerated aging. The duration of thermostating is expressed in weeks, and the viscosity in centipoises.

The formula of the composition is given for each example, and the corresponding table shows the viscosity trend of the preparations over time.

All percentages are expressed by weight, by reference to the weight of the compositions.

### Example n^{o} 1

| | | Composition | Composition |
|---|---|---|---|
| | Reference | of the prior | of the |
| Ingredients | composition | art | invention |
| Polygel ® DKP (1) | 2% | 2% | 2% |
| TMP-NO (2) | ÷ | | 0.3% |
| p-methoxybenzaldehyde | ÷ | 0.3% | |
| Sodium hypochlorite (AvCl₂) | 5% | 5% | 5% |
| KOH (50% sol.) | to pH 12.5 | to pH 12.5 | to pH 12.5 |
| Demineralized water | 100% | 100% | 100% |

(1) Polygel ® DKP is a cross-linked polyacrylic acid.
(2) Stabiliser with formula (I) wherein X₁ represents oxygen, X₂ is hydrogen, X₃ is OH, and groups R₁, R₂, R₃, R₄ represent methyl.

TABLE 1

| | Reference | | Composition | | Composition | |
|---|---|---|---|---|---|---|
| | composition | | of the prior art | | of the invention | |
| | | Active | | Active | | Active |
| Weeks | Viscosity | chlorine | Viscosity | chlorine | Viscosity | chlorine |
| 0 | 820 | 5% | 610 | 5% | 1200 | 5% |
| 1 | 1250 | 3.8% | 820 | 4.3% | 1640 | 4.5% |
| 2 | 1750 | 3.58% | 1350 | 3.61% | 2150 | 4.36% |
| 3 | 1225 | 3.23% | 1550 | 3.64% | 2150 | 3.97% |
| 4 | 1050 | 3% | 1725 | 3.25% | 2150 | 3.68% |
| 8 | 0 | 2.24% | 1200 | 2.46% | 1500 | 3.5% |
| 12 | 0 | 1.87% | 1000 | 1.91% | 1640 | 3% |

### Example n^{o} 2

| | Reference | Composition |
|---|---|---|
| Ingredients | composition | of the invention |
| Polygel ® DKP | 2% | 2% |
| TMP-NO | — | 0.3% |
| Empigen OB (1) | 3% | 3% |
| Sodium hypochlorite (AvCl₂) | 5% | 5% |
| KOH (50% sol.) | to pH 12.5 | to pH 12.5 |
| Demineralized water | 100% | 100% |

(1) Alkyl dimethylamine oxide.

TABLE 2

| | Viscosity | |
|---|---|---|
| Weeks | Reference composition | Composition of the invention |
| 0 | 820 | 1250 |
| 1 | 1250 | 1700 |
| 2 | 1850 | 2000 |
| 3 | 1350 | 2150 |
| 4 | 1150 | 2100 |
| 8 | 0 | 1600 |
| 12 | 0 | 1650 |

### Example n^{o} 3

| | Reference | Composition of |
|---|---|---|
| Ingredients | composition | the invention |
| Polygel ® DKP | 2% | 2% |
| TMP-NO | — | 0.3% |
| Aromox BW270 (1) | 3% | 3% |
| Edenor C12 (2) | 1% | 1% |
| Sodium hypochlorite (AvCl₂) | 5% | 5% |
| NaOH (30% sol.) | to pH 12.5 | to pH 12.5 |
| Demineralized water | 100% | 100% |

(1) Alkyl dimethyl-C12-18 amine oxide.
(2) Lauric acid.

TABLE 3

| | Viscosity | |
|---|---|---|
| Weeks | Reference composition | Composition of the invention |
| 0 | 950 | 1000 |
| 1 | 1100 | 1400 |
| 2 | 1500 | 1900 |
| 3 | 1300 | 2000 |
| 4 | 900 | 2150 |
| 8 | 0 | 1700 |
| 12 | 0 | 1800 |

### Example n^{o} 4

| | | Composition | Composition |
|---|---|---|---|
| | Reference | of the prior | of the |
| Ingredients | composition | art | invention |
| Polygel ® DKP (1) | 2% | 2% | 2% |
| TMP-NH (2) | ÷ | | 0.3% |
| Oxyrite | ÷ | 0.3% | |
| Sodium hypochlorite | 5% | 5% | 5% |
| (AvCl₂) | | | |
| KOH (50% sol.) | to pH 12.5 | to pH 12.5 | to pH 12.5 |
| Demineralized water | 100% | 100% | 100% |

(1) Polygel ® DKP is a cross-linked polyacrylic acid.
(2) Stabiliser with formula (I) wherein X₁ and X₂ represent hydrogen, X₃ is OH, and groups R₁, R₂, R₃ and R₄ represent methyl.

TABLE 4

| | Viscosity | | |
|---|---|---|---|
| | Reference | Composition of | Composition of |
| Weeks | composition | the prior art | the invention |
| 0 | 1160 | 650 | 1080 |
| 1 | 1200 | 900 | 1440 |
| 2 | 1500 | 1300 | 1850 |
| 3 | 1400 | 1500 | 1800 |
| 4 | 1200 | 1450 | 2150 |
| 8 | 0 | 1200 | 1800 |
| 12 | 0 | 1000 | 1800 |

### Example n^{o} 5

| | Reference | Composition of |
|---|---|---|
| Ingredients | composition | the invention |
| Polygel ® DKP | 2% | 2% |
| TMP-NH | — | 0.3% |
| Empigen OB | 3% | 3% |
| Sodium hypochlorite (AvCl₂) | 5% | 5% |
| KOH (50% sol.) | to pH 12.5 | to pH 12.5 |
| Demineralized water | 100% | 100% |

TABLE 5

| | Viscosity | |
|---|---|---|
| Weeks | Reference composition | Composition of the invention |
| 0 | 1160 | 1100 |
| 1 | 1200 | 1400 |
| 2 | 1500 | 1800 |
| 3 | 1700 | 1950 |
| 4 | 1800 | 2000 |
| 8 | 0 | 1800 |
| 12 | 0 | 1900 |

### Example n^{o} 6

| | | Composition of |
|---|---|---|
| Ingredients | Reference composition | the invention |
| Acusol ® 820 (1) | 6% | 6% |
| TMP-NO | ÷ | 0.3% |
| Sodium hypochlorite (AvCl₂) | 6% | 6% |
| NaOH (50% sol.) | to pH 12.5 | to pH 12.5 |
| Demineralized water | 100% | 100% |

(1) 30% emulsion of hydrophobically modified acrylic polymer.

TABLE 6

| | Viscosity | |
|---|---|---|
| Weeks | Reference composition | Composition of the invention |
| 0 | 850 | 900 |
| 1 | 900 | 1100 |
| 2 | 1200 | 1500 |
| 3 | 1300 | 1600 |
| 4 | 1100 | 1700 |
| 8 | 0 | 1500 |
| 12 | 0 | 1500 |

### Example n^{o} 7

| | Reference | Composition of |
|---|---|---|
| Ingredients | composition | the invention |
| Pemulen ® TR1 (1) | 2% | 2% |
| TMP-NO | — | 0.3% |
| Aromox BW270 | 3% | 3% |
| Edenor C12 | 1% | 1% |
| Sodium hypochlorite (AvCl₂) | 5% | 5% |
| NaOH (30% sol.) | to pH 12.5 | to pH 12.5 |
| Demineralized water | 100% | 100% |

(1) Acrylic acid/stearyl methacrylate copolymer.

TABLE 7

| | Viscosity | |
|---|---|---|
| Weeks | Reference composition | Composition of the invention |
| 0 | 850 | 900 |
| 1 | 950 | 1100 |
| 2 | 1100 | 1300 |
| 3 | 1100 | 1500 |
| 4 | 700 | 1650 |
| 8 | 0 | 1500 |
| 12 | 0 | 1500 |

### Example n^{o} 8

A sample of 14% commercial sodium hypochlorite in active chlorine was diluted with demineralised water to an active chlorine content of 5%, and the pH was stabilised at approx. 14 with the addition of caustic soda.

The sample was divided into three portions of equal weight. One of them was left unchanged; 0.1% of stabiliser with formula (I), wherein X₁ represents oxygen, X₂=hydrogen, X₃=OH and groups R₁, R₂, R₃ and R₄ represent methyl (TMP-NO), was added to the second portion; and 0.3% of the same TMP-NO stabiliser was added to the third portion.

The samples were subjected to accelerated aging in a stove thermostated at 40° C.

The results are summarised in Table 8.

TABLE 8

| | unstabilised | stabilised with | stabilised with |
|---|---|---|---|
| Weeks at | solution | 0.1% of TMP-NO | 0.3% of TMP-NO |
| 40° C. | % active chlorine | % active chlorine | % active chlorine |
| 0 | 5 | 5 | 5 |
| 1 | 4.1 | 4.8 | 4.8 |
| 2 | 3.8 | 4.5 | 4.6 |
| 3 | 3.5 | 4.1 | 4.1 |
| 4 | 3.1 | 3.7 | 3.9 |
| 8 | 2 | 3.2 | 3.7 |
| 12 | 0.5 | 3 | 3.5 |

### Example n^{o} 9

A sample of 14% commercial sodium hypochlorite in active chlorine was diluted with demineralised water to an active chlorine content of 5%, and the pH was stabilised at approx. 14 with the addition of caustic soda.

The sample was divided into three portions of equal weight. One of them was left unchanged; phosphonic acid was added to the second portion, and 0.1% of stabiliser with formula (I), wherein X₁ represents oxygen, X₂=hydrogen, X₃=OH and groups R₁, R₂, R₃ and R₄ represent methyl (TMP-NO), was added to the third portion.

The samples were subjected to accelerated aging in a stove thermostated at 40° C.

The results are summarised in Table 9.

TABLE 9

| | | | Stabilised with |
|---|---|---|---|
| | | Stabilised with | 0.1% phosphonic |
| | Unstabilised | 0.1% phosphonic | acid and 0.1% |
| Weeks at | solution | acid | TMP-NO |
| 40° C. | % active chlorine | % active chlorine | % active chlorine |
| 0 | 5 | 5 | 5 |
| 1 | 4.1 | 4.8 | 4.8 |
| 2 | 3.8 | 4.6 | 4.8 |
| 3 | 3.5 | 4.1 | 4.7 |
| 4 | 3.1 | 3.9 | 4.2 |
| 8 | 2 | 3.7 | 4.1 |
| 12 | 0.5 | 3.5 | 4 |

### Example n^{o} 10

A sample of 14% commercial sodium hypochlorite in active chlorine was diluted with demineralised water to an active chlorine content of 5%, and the pH was stabilised at approx. 14 with the addition of caustic soda.

The sample also contains 3% lauryl ether sulphate 3EO; the sample was divided into three portions of equal weight. One of them was left unchanged; 0.05% sodium periodate was added to the second portion, and 0.1% of stabiliser with formula (I), wherein X₁ represents oxygen, X₂=hydrogen, X₃=OH and groups R₁, R₂, R₃ and R₄ represent methyl (TMP-NO), was added to the third portion.

The samples were subjected to accelerated aging in a stove thermostated at 40° C.

The results are summarised in Table 10.

TABLE 10

| | | | Stabilised with |
|---|---|---|---|
| | | Stabilised with | 0.05% sodium |
| | Unstabilised | 0.05% sodium | periodate and 0.1% |
| Weeks at | solution | periodate | TMP-NO |
| 40° C. | % active chlorine | % active chlorine | % active chlorine |
| 0 | 5 | 5 | 5 |
| 1 | 4.1 | 4.7 | 4.9 |
| 2 | 3.8 | 4.7 | 4.7 |
| 3 | 3.5 | 4.2 | 4.5 |
| 4 | 3.1 | 3.9 | 4.2 |
| 8 | 2 | 3.6 | 4.0 |
| 12 | 0.5 | 3.4 | 3.9 |

1. Method for stabilising the viscosity and/or the active chlorine content of liquid compositions containing alkali or alkaline-earth hypochlorites, comprising the addition to said compositions of 0.001% to 5% by weight of compounds belonging to the class of hindered amines containing the group: 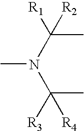
wherein R₁, R₂, R₃ and R₄, which may be the same or different, represent methyl or ethyl.

2. Method as claimed in claim 1, wherein the hindered amine has the general formula (I): 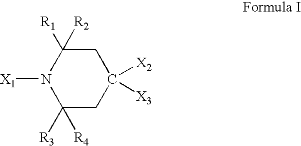
wherein R₁, R₂, R₃ and R₄, which may be the same or different, represent methyl or ethyl; X₁ represents H, methyl, ethyl, an oxygen atom, an —OH group or an OR₅ group, wherein R₅ represents linear or branched alkyl C₁-C₄ or cyclohexyl; X₂ represents hydrogen and X₃ represents the groups —OH or —NHR₅, wherein R₅ has the meaning described above; or X₂ and X₃, taken together, represent an oxygen atom.

3. Method as claimed in claim 2, wherein groups R₁, R₂, R₃ and R₄ represent methyl.

4. Method as claimed in claim 2, wherein X₁ represents oxygen, X₂ is hydrogen, X₃ is OH, and groups R₁, R₂, R₃ and R₄ represent methyl.

5. Method as claimed in claim 2, wherein X₁ and X₂ represent hydrogen, X₃ represents —OH, and groups R₁, R₂, R₃ and R₄ represent methyl.

6. Method as claimed in claims 1-5, wherein liquid compositions containing active chlorine are thickened with soluble or water-dispersible polymers.

7. Method as claimed in claim 6, wherein the thickening polymers are homo- or co-polymers of acrylic acid.

8. Method as claimed in claim 6, wherein the thickening polymers are homo- or co-polymers of cross-linked acrylic acid.

9. Method as claimed in claims 1 to 5, wherein the amount of stabiliser is between 0.005% and 3% by weight.

10. Method as claimed in claims 1 to 5, wherein the active chlorine is present in the amount of between 0.5% and 10% by weight of the liquid composition.

11. Method as claimed in claims 1 to 5, wherein the liquid compositions are detergent compositions for domestic and industrial cleaning and disinfection.

12. Method as claimed in claims 1 to 5, wherein the liquid compositions are detergent compositions for domestic and industrial cleaning and disinfection containing chelating agents of metal ions present alone or in combination with one another.

13. Method as claimed in claims 1 to 5, wherein the liquid compositions are detergent compositions for domestic and industrial cleaning and disinfection containing hypochlorite stabilisers, generally present alone or in combination with one another.

14. Liquid detergent compositions for domestic and industrial cleaning, stabilised as claimed in claims 1 to 13.

15. Mixtures of cross-linked or not cross-linked acrylic homo- or co-polymers comprising up to 50% by weight of hindered amines of formula I.
